(19) United States
(12) Patent Application Publication
(10) Pub. No.: US 2016/0157510 A1
(43) Pub. Date: Jun. 9, 2016

(54) PRODUCTION OF SOY PROTEIN PRODUCTS WITH REDUCED ASTRINGENCY (I)

(71) Applicant: Burcon NutraScience (MB) Corp., Winnipeg (CA)

(72) Inventors: Martin SCHWEIZER, Winnipeg (CA); Sarah MEDINA, Winnipeg (CA); Kevin I. SEGALL, Winnipeg (CA)

(73) Assignee: Burcon NutraScience (MB) Corp., Winnipeg (CA)

(21) Appl. No.: 14/872,410

(22) Filed: Oct. 1, 2015

Related U.S. Application Data
(60) Provisional application No. 62/058,154, filed on Oct. 1, 2014.

(51) Int. Cl. A23J 1/14

(52) U.S. Cl. CPC A23J 1/14

(57) ABSTRACT

The present invention is directed to soy protein products of reduced astringency. The reduced astringency soy protein products may be obtained by using a pH adjustment step to fractionate soy protein solutions, which provide soy protein products which are completely soluble and heat stable in aqueous media at acid pH value of less than about 4.4, into lower molecular weight, less astringent proteins and higher molecular weight, more astringent proteins.

### FIELD OF THE INVENTION

The present invention relates to novel and inventive soy protein products, preferably soy protein isolates and novel and inventive methods for the production thereof. More particularly, the present invention relates to soy protein products of reduced astringency.

### BACKGROUND TO THE INVENTION

In U.S. patent application Ser. No. 12/603,087 filed Oct. 21, 2009 (now U.S. Pat. No. 8,691,318), Ser. No. 12/923,897 filed Oct. 13, 2010 (now U.S. Pat. No. 8,563,071), and Ser. No. 13/879,418 filed Aug. 1, 2013 (published as US Patent Application Publication No. 20130316069), assigned to the assignee hereof and the disclosures of which are incorporated herein by reference, there is described the provision of soy protein products having a protein content of at least about 60 wt % (N×6.25) on a dry weight basis (d.b.), preferably soy protein isolates having a protein content of at least about 90 wt % (N×6.25) d.b. These soy protein products have a unique combination of properties, namely:
completely soluble in aqueous media at acid pH values of less than about 4.4;
heat stable in aqueous media at acid pH values of less than about 4.4;
do not require stabilizers or other additives to maintain the protein product in solution;
are low in phytic acid; and
require no enzymes in the production thereof.

In addition, these soy protein products have no beany flavour or off odours characteristic of some other soy protein products.

These novel and inventive soy protein products are prepared by methods which comprise:
(a) extracting a soy protein source with an aqueous calcium salt solution, preferably an aqueous calcium chloride solution, to cause solubilization of soy protein from the protein source and to form an aqueous soy protein solution,
(b) separating the aqueous soy protein solution from residual soy protein source,
(c) optionally diluting the aqueous soy protein solution,
(d) adjusting the pH of the aqueous soy protein solution to a pH of about 1.5 to about 4.4, preferably about 2 to about 4, to produce an acidified clear soy protein solution,
(e) optionally concentrating the acidified clear soy protein solution while maintaining the ionic strength substantially constant by a selective membrane technique,
(f) optionally diafiltering the optionally concentrated soy protein solution, and
(g) optionally drying the optionally concentrated and optionally diafiltered soy protein solution.

These soy protein products are preferably isolates having a protein content of at least about 90 wt %, preferably at least about 100 wt % (N×6.25) d.b.

In certain acidic beverages, particularly those having a pH at the low end of the acceptable pH range for acidic beverages, these soy protein products may, in some cases, induce an astringent sensation in the mouth.

### SUMMARY OF THE INVENTION

It has now been determined by the present inventors, and disclosed for the first time in the present application and in the application from which the present application claims priority, that this astringency can be reduced or eliminated by modifying the procedure used to manufacture the soy protein products.

In accordance with an aspect of the present invention, the process is modified to remove proteins which precipitate at a pH of about 5 to about 6.5, which removed proteins, without wishing to be bound by theory, may interact with salivary proteins to induce astringency, and thus their removal thereby produces a less astringent product. In order to precipitate the protein fraction, the pH of the acidified protein solution, preferably after partial concentration and diafiltration, is adjusted to about 5.0 to about 6.5, preferably about 5.5 to about 6.0. The precipitated protein is removed and the protein that remains in solution is then re-acidified and further membrane processed to form the products of the present invention. The less astringent proteins that remain in solution when the aforementioned precipitation method is applied appear to be of lower molecular weight than the more astringent species that are removed from the solution. The less astringent proteins may be separated from contaminants by a subsequent concentration and/or diafiltration step using a membrane of suitable molecular weight cut-off. The purified less astringent protein factor is a product of the present invention.

In an embodiment of the present invention, the re-acidified protein solution has a pH of about 1.5 to about 4.4. In another embodiment of the present invention, the pH of the re-acidified protein solution is about 2.0 to about 4.0.

In an embodiment of the present invention, the re-acidified protein solution is concentrated to a protein content of about 10 to about 300 g/L. In another embodiment of the present invention, the re-acidified protein solution is concentrated to a protein content of about 100 to about 200 g/L. In another embodiment of the present invention, the re-acidified protein solution is partially concentrated to a protein content of less than about 10 g/L.

In an embodiment of the present invention, the re-acidified protein solution is concentrated by ultrafiltration using a membrane having a molecular weight cut-off of about 1,000 to about 1,000,000 daltons. In another embodiment of the present invention, the re-acidified protein solution is concentrated by ultrafiltration using a membrane having a molecular weight cut-off of about 1,000 to about 100,000 daltons. In another embodiment of the present invention, the re-acidified protein solution is concentrated by ultrafiltration using a membrane having a molecular weight cut-off of about 1,000 to about 10,000 daltons.

In an embodiment of the present invention, the concentrated or partially concentrated re-acidified protein solution is diafiltered using water or acidified water. In another embodiment of the present invention, the concentrated or partially concentrated re-acidified protein solution is diafiltered using a dilute saline solution or an acidified dilute saline solution, such as for example, but not limited to, dilute calcium chloride and/or sodium chloride solution or acidified dilute calcium chloride and/or sodium chloride solution.

In accordance with another aspect of the present invention, there is provided a soy protein product having a protein content of at least about 60 wt % (N×6.25) d.b. and which
is completely soluble in aqueous media at acid pH values of less than about 4.4;
is heat stable in aqueous media at acid values of less than about 4.4;
does not require stabilizers or other additives to maintain the protein product in solution or suspension;
is low in phytic acid; and
is low in astringency when tasted in aqueous solution at a pH below about 5.

In an embodiment of the present invention, no enzymes are utilized in the production of the soy protein products of the present invention.

In an embodiment of the present invention, the soy protein product has a protein content of at least about 90 wt % (N×6.25) d.b. In another embodiment, the soy protein product has a protein content of at least about 100 wt % (N×6.25) d.b.

In an embodiment of the present invention, the soy protein product is not hydrolysed.

In an embodiment of the present invention, the soy protein product has a phytic acid content of less than about 1.5 wt %. In another embodiment of the present invention, the soy protein product has a phytic acid content of less than about 0.5 wt %.

In accordance with another aspect of the present invention, there is provided a soy protein product having a protein content of at least about 60 wt % (N×6.25) d.b., having low astringency when tasted in aqueous solution at a pH of below about 5 and which is substantially completely soluble in an aqueous medium at a pH of less than about 4.4.

In an embodiment of the present invention, the soy protein product is blended with water soluble powdered materials for the production of aqueous solutions of the blend. In an embodiment of the present invention, the water soluble powdered materials are a powdered beverage.

In an embodiment of the present invention, the soy protein product is in an aqueous solution which is heat stable at a pH of less than about 4.4.

In an embodiment of the present invention, the aqueous solution is a beverage. In an embodiment of the present invention, the beverage is a clear beverage in which the dissolved soy protein product of the present invention is completely soluble and transparent. In another embodiment of the present invention, the beverage is a non-transparent beverage in which the dissolved soy protein product of the present invention does not increase the cloud or haze level of the non-transparent beverage.

In accordance with another aspect of the present invention, there is provided a soy protein product having a molecular weight profile, which is:

about 0 to about 80% greater than about 100,000 Da;

about 0 to about 50% from about 15,000 to about 100,000 Da;

about 0 to about 35% from about 5,000 to about 15,000 Da; and

about 0 to about 20% from about 1,000 to about 5,000 Da.

In an embodiment of the present invention, the molecular weight profile is:

about 40 to about 70% greater than about 100,000 Da;

about 20 to about 40% from about 15,000 to about 100,000 Da;

about 0 to about 15% from about 5,000 to about 15,000 Da; and

about 0 to about 10% from about 1,000 to about 5,000 Da.

In accordance with another aspect of the present invention, there is provided a soy protein product having a molecular weight profile, which is:

about 39 to about 72% greater than about 100,000 Da;

about 22 to about 44% from about 15,000 to about 100,000 Da;

about 0 to about 20% from about 5,000 to about 15,000 Da; and

about 0 to about 18% from about 1,000 to about 5,000 Da.

In an embodiment of the present invention, the molecular weight profile is:

about 44 to about 67% greater than about 100,000 Da;

about 27 to about 39% from about 15,000 to about 100,000 Da;

about 0 to about 15% from about 5,000 to about 15,000 Da; and

about 0 to about 13% from about 1,000 to about 5,000 Da.

In an embodiment of the present invention, the molecular weight profile is determined by size exclusion chromatography at a pH of about 3.5. In another embodiment of the present invention, the molecular weight profile is determined by the method described in Example 19.

In an embodiment of the present invention, the protein content of the product is at least about 60 wt % (N×6.25) d.b., and the protein solubility at 1% protein w/v in water at a pH of about 5 to about 6 is greater than about 60%. In another embodiment of the present invention, the protein solubility at 1% protein w/v in water at a pH of about 5 to about 6 is greater than about 60% when determined by the protein method described in Example 3.

In an embodiment of the present invention, the protein content of the product is at least about 60 wt % (N×6.25) d.b. and the L* reading for a solution prepared by dissolving sufficient protein powder to supply 0.48 g of protein in 15 ml of water is greater than about 96.50.

In accordance with another aspect of the present invention, there is provided a soy protein product having a molecular weight profile, which is:

about 6 to about 36% greater than about 100,000 Da;

about 38 to about 64% from about 15,000 to about 100,000 Da;

about 0 to about 28% from about 5,000 to about 15,000 Da; and

about 1 to about 28% from about 1,000 to about 5,000 Da.

In an embodiment of the present invention, the molecular weight profile is:

about 14 to about 31% greater than about 100,000 Da;

about 43 to about 59% from about 15,000 to about 100,000 Da;

about 4 to about 20% from about 5,000 to about 15,000 Da; and

about 6 to about 23% from about 1,000 to about 5,000 Da.

In an embodiment of the present invention, the molecular weight profile is determined by size exclusion chromatography at a pH of about 6. In another embodiment of the present invention, the molecular weight profile is determined by the method described in Example 20.

In an embodiment of the present invention, the protein content of the product is at least about 60 wt % (N×6.25) d.b., and the protein solubility at 1% protein w/v in water at a pH of about 5 to about 6 is greater than about 60%. In another embodiment of the present invention, the protein solubility at 1% protein w/v in water at a pH of about 5 to about 6 is greater than about 60% when determined by the protein method described in Example 3.

In an embodiment of the present invention, the protein content of the product is at least about 60 wt % (N×6.25) d.b. and the L* reading for a solution prepared by dissolving sufficient protein powder to supply 0.48 g of protein in 15 ml of water is greater than about 96.50.

In accordance with another aspect of the present invention, there is provided a soy protein product which has a protein content of at least about 60 wt % (N×6.25) d.b. and which has a solubility at 1% protein w/v in water at a pH of about 2 to about 7 of greater than about 50%.

In an embodiment of the present invention, there is provided a soy protein product which has a protein content of at least about 60 wt % (N×6.25) d.b. and which has a protein solubility at 1% protein w/v in water at a pH of about 2 to about 7 of greater than about 50% when determined by the protein method described in Example 3.

In an embodiment of the present invention, there is provided a soy protein product which has a protein content of at least about 60 wt % (N×6.25) d.b. and which has a total product solubility at 1% protein w/v in water at a pH of about 2 to about 7 is greater than about 50% when determined by the pellet method described in Example 3.

In an embodiment of the present invention, there is provided a soy protein product which has protein content of the product is at least about 60 wt % (N×6.25) d.b. and the L* reading for a solution prepared by dissolving sufficient protein powder to supply 0.48 g of protein in 15 ml of water is greater than about 96.50.

In an embodiment of the present invention, the soy protein product has a protein content of at least about 90 wt % (N×6.25) d.b. In another embodiment of the present invention, the soy protein product has a protein content of at least about 100 wt % (N×6.25) d.b.

In accordance with another aspect of the present invention, the precipitated larger, more astringent protein species may be further processed and optionally adjusted in pH, as described below to form a product intended typically for use in neutral applications, such as processed meat products, baked goods, nutrition bars and dairy analogue or alternative products.

In an embodiment of the present invention, the larger, more astringent protein species may be further processed as follows:

1. Optionally washed with water then optionally dried by any conventional means, such as, for example by, but not limited to, spray drying or freeze drying, or

2. Optionally washed with water, then adjusted to a pH within the range of about 6 to about 8 and then optionally dried, or

3. Re-dispersed in water, adjusted to a pH of about 1.5 to about 4.4, preferably about 2 to about 4, then membrane processed and then optionally dried, or

4. Re-dispersed in water, adjusted to a pH of about 1.5 to about 4.4, preferably about 2 to about 4, then membrane processed, then adjusted in pH to about 6 to about 8, and then optionally dried.

In accordance with another aspect of the present invention, there is provided a soy protein product having a molecular weight profile, which is:

about 25 to about 100% greater than about 100,000 Da;

about 0 to about 50% from about 15,000 to about 100,000 Da;

about 0 to about 18% from about 5,000 to about 15,000 Da; and

about 0 to about 42% from about 1,000 to about 5,000 Da.

In an embodiment of the present invention, the molecular weight profile is:

about 25 to about 45% greater than about 100,000 Da;

about 30 to about 47% from about 15,000 to about 100,000 Da;

about 5 to about 15% from about 5,000 to about 15,000 Da; and

about 8 to about 26% from about 1,000 to about 5,000 Da.

In accordance with another aspect of the present invention, there is provided a soy protein product having a molecular weight profile, which is:

about 20 to about 52% greater than about 100,000 Da;

about 27 to about 51% from about 15,000 to about 100,000 Da;

about 0 to about 21% from about 5,000 to about 15,000 Da; and

about 3 to about 31% from about 1,000 to about 5,000 Da.

In an embodiment of the present invention, the molecular weight profile is:

about 25 to about 47% greater than about 100,000 Da;

about 32 to about 46% from about 15,000 to about 100,000 Da;

about 3 to about 16% from about 5,000 to about 15,000 Da; and

about 8 to about 26% from about 1,000 to about 5,000 Da.

In an embodiment of the present invention, the molecular weight profile is determined by size exclusion chromatography at a pH of about 3.5. In another embodiment of the present invention, the molecular weight profile is determined by the method described in Example 19.

In an embodiment of the present invention, the protein content of the product is at least about 60 wt % (N×6.25) d.b., the protein solubility at 1% protein w/v in water at a pH of about 2 is about 30 to about 50%, and the protein solubility at 1% protein w/v in water at a pH of about 7 is less than about 30%.

In an embodiment of the present invention, the protein content of the product is at least about 60 wt % (N×6.25) d.b., the protein solubility at 1% protein w/v in water at a pH of about 2 is about 30 to about 50%, and the protein solubility at 1% protein w/v in water at a pH of about 7 is less than about 30% when determined by the protein method described in Example 14.

In accordance with another aspect of the present invention, there is provided a soy protein product having a molecular weight profile, which is:

about 1 to about 80% greater than about 100,000 Da;

about 8 to about 33% from about 15,000 to about 100,000 Da;

about 0 to about 13% from about 5,000 to about 15,000 Da; and

about 4 to about 65% from about 1,000 to about 5,000 Da.

In an embodiment of the present invention, the molecular weight profile is:

about 6 to about 75% greater than about 100,000 Da;

about 13 to about 28% from about 15,000 to about 100,000 Da;

about 3 to about 10% from about 5,000 to about 15,000 Da; and

about 9 to about 60% from about 1,000 to about 5,000 Da.

In an embodiment of the present invention, the molecular weight profile is determined by size exclusion chromatography at a pH of about 6. In another embodiment of the present invention, the molecular weight profile is determined by the method described in Example 20.

In an embodiment of the present invention, the protein content of the product is at least about 60 wt % (N×6.25) d.b., the protein solubility at 1% protein w/v in water at a pH of about 2 is about 30 to about 50%, and the protein solubility at 1% protein w/v in water at a pH of about 7 is less than about 30%.

In an embodiment of the present invention, the protein content of the product is at least about 60 wt % (N×6.25) d.b., the protein solubility at 1% protein w/v in water at a pH of about 2 is about 30 to about 50%, and the protein solubility at 1% protein w/v in water at a pH of about 7 is less than about 30%, when determined by the protein method described in Example 14.

In an embodiment of the present invention, the phytic acid content of the product is less than about 1 wt %.

The reduced astringency soy protein products of the present invention as described herein, produced according to the processes of the present invention described herein, are particularly suitable for use in protein fortification of acid media. However, the reduced astringency soy protein products of the present invention, as well as the co-products of their production, containing the higher astringency proteins, may also be used in a wide variety of conventional applications of protein products, including but not limited to protein fortification of processed foods and beverages and as functional ingredients in foods and beverages. The soy protein products of the present invention may also be used in dairy analogue or dairy alternative products, including products that are dairy/plant ingredient blends. The soy protein products of the present invention may also be used in nutritional supplements. Other uses of the soy protein products of the present invention would be understood by persons skilled in the art and may include, but not limited to, use in pet foods, in animal feed, in industrial and cosmetic applications and in personal care products.

### GENERAL DESCRIPTION OF INVENTION

The initial step of the process of the present invention of providing the soy protein products of the present invention involves solubilizing soy protein from a soy protein source. The soy protein source may be soybeans or any soy product or by-product derived from the processing of soybeans, including but not limited to soy meal, soy flakes, soy grits and soy flour. The soy protein source may be used in the full fat form, partially defatted form or fully defatted form. Where the soy protein source contains an appreciable amount of fat, an oil removal step generally is required during the process. The soy protein recovered from the soy protein source may be the protein naturally occurring in soybean or the proteinaceous material may be a protein modified by genetic manipulation but possessing characteristic hydrophobic and polar properties of the natural protein.

Protein solubilization from the soy protein source material is effected most conveniently using calcium chloride solution, although solutions of other calcium salts may be used. In addition, other alkaline earth metal compounds may be used, such as magnesium salts. Further, extraction of the soy protein from the soy protein source may be effected using calcium salt solution in combination with another salt solution, such as sodium chloride. Alternatively, extraction of the soy protein from the soy protein source may be effected using water or other salt solution, such as sodium chloride, with calcium salt subsequently being added to the aqueous soy protein solution produced in the extraction step. Precipitate formed upon addition of the calcium salt is removed prior to subsequent processing.

As the concentration of the calcium salt solution increases, the degree of solubilization of protein from the soy protein source initially increases until a maximum value is achieved. Any subsequent increase in salt concentration does not increase the total protein solubilized. The concentration of calcium salt solution which causes maximum protein solubilization varies depending on the salt concerned. It is usually preferred to utilize a concentration value less than about 1.0 M, and more preferably a value of about 0.10 to about 0.15 M.

In a batch process, the salt solubilization of the protein is effected at a temperature of from about 1° to about 100° C., preferably about 15° C. to about 65° C., more preferably about 50° to about 60° C., preferably accompanied by agitation to decrease the solubilization time, which is usually about 1 to about 60 minutes. It is preferred to effect the solubilization to extract substantially as much protein from the soy protein source as is practical, so as to provide an overall high product yield.

In a continuous process, the extraction of the soy protein from the soy protein source is carried out in any manner consistent with effecting a continuous extraction of protein from the soy protein source. In one embodiment, the soy protein source is continuously mixed with the calcium salt solution and the mixture is conveyed through a pipe or conduit having a length and at a flow rate for a residence time sufficient to effect the desired extraction in accordance with the parameters described herein. In such a continuous procedure, the salt solubilization step is effected in a time of about 1 minute to about 60 minutes, preferably to effect solubilization to extract substantially as much protein from the soy protein source as is practical. The solubilization in the continuous procedure is effected at temperatures between about 1° and about 100° C., preferably between about 15° C. and about 65° C., more preferably between about 50° and about 60° C.

The extraction is generally conducted at a pH of about 4.5 to about 11, preferably about 5 to about 7. The pH of the extraction system (soy protein source and calcium salt solution) may be adjusted to any desired value within the range of about 4.5 to about 11 for use in the extraction step by the use of any conventional food grade acid, such as, for example, but not limited to, hydrochloric acid or phosphoric acid or mixtures thereof, preferably hydrochloric acid, as required or any conventional food grade alkali, such as, for example, but not limited to sodium hydroxide or potassium hydroxide or mixtures thereof, preferably sodium hydroxide, as required.

The concentration of soy protein source in the calcium salt solution during the solubilization step may vary widely. Typical concentration values are about 5 to about 15% w/v.

The protein extraction step with the aqueous calcium salt solution has the additional effect of solubilizing fats which may be present in the soy protein source, which then results in the fats being present in the aqueous phase.

The protein solution resulting from the extraction step generally has a protein concentration of about 5 to about 50 g/L, preferably about 10 to about 50 g/L.

The aqueous calcium salt solution used for extraction may contain an antioxidant. The antioxidant may be any conventional antioxidant, such as, for example, but not limited to, sodium sulfite or ascorbic acid or mixtures thereof. The quantity of antioxidant employed may vary from about 0.01 to about 1 wt % of the solution, preferably about 0.05 wt %. The antioxidant serves to inhibit oxidation of any phenolics in the protein solution.

The aqueous protein solution resulting from the extraction step then may be separated from the residual soy protein source, in any conventional manner, such as by employing a decanter centrifuge or any suitable sieve, followed by disc centrifugation and/or filtration, to remove residual soy protein source material. The separation step is typically conducted at the same temperature as the protein solubilisation step, but may be conducted at any temperature within the range of about 1° to about 100° C., preferably about 15° to about 65° C., more preferably about 50° to about 60° C. The separated residual soy protein source may be dried for disposal or further processed to recover residual protein. The separated residual soy protein source may be re-extracted with fresh calcium salt solution and the protein solution yielded upon clarification combined with the initial protein solution for further processing as described below. A counter-current extraction procedure may also be utilized. Alternatively, the separated residual soy protein source may be processed by any other conventional procedure to recover residual protein.

The aqueous soy protein solution may be treated with an anti-foamer, such as any conventionally suitable food-grade, non-silicone based anti-foamer, to reduce the volume of foam formed upon further processing. The quantity of anti-foamer employed is generally greater than about 0.0003% w/v. Alternatively, the anti-foamer in the quantity described may be added in the extraction steps.

Where the soy protein source contains significant quantities of fat, as described in U.S. Pat. Nos. 5,844,086 and 6,005,076, assigned to the assignee hereof and the disclosures of which are incorporated herein by reference, then the defatting steps described therein may be effected on the separated aqueous protein solution. Alternatively, defatting of the separated aqueous soy protein solution may be achieved by any other conventional procedure.

The aqueous soy protein solution may be treated with an adsorbent, such as powdered activated carbon or granulated activated carbon, to remove colour and/or odour compounds. Such adsorbent treatment may be carried out under any conventional conditions, generally at the ambient temperature of the separated aqueous protein solution. For powdered activated carbon, an amount of about 0.025% to about 5% w/v, preferably about 0.05% to about 2% w/v, may be employed. The adsorbing agent may be removed from the soy protein solution by any conventional means, such as by filtration.

The resulting aqueous soy protein solution may be diluted generally with about 0.1 to about 10 volumes, preferably about 0.5 to about 2 volumes of aqueous diluent, in order to decrease the conductivity of the aqueous soy protein solution to a value of generally below about 105 mS, preferably about 4 to about 21 mS. Such dilution is usually effected using water, although dilute salt solution, such as for example, but not limited to, sodium chloride or calcium chloride, having a conductivity up to about 3 mS, may be used.

The diluent with which the soy protein solution is mixed generally has the same temperature as the soy protein solution, but the diluent may have a temperature of about 1° to about 100° C., preferably about 15° to about 65° C., more preferably about 50° to about 60° C.

The optionally diluted soy protein solution then is adjusted in pH to a value of about 1.5 to about 4.4, preferably about 2 to about 4, by the addition of any conventionally suitable food grade acid, such as, for example, but not limited to, hydrochloric acid or phosphoric acid or mixtures thereof, preferably hydrochloric acid, to result in a clear acidified aqueous soy protein solution. The clear acidified aqueous soy protein solution has a conductivity of generally below about 110 mS for a diluted soy protein solution, or generally below about 115 mS for an undiluted soy protein solution, in both cases preferably about 4 to about 26 mS.

As described in co-pending U.S. patent application Ser. No. 13/474,788 filed May 18, 2012 (“S704”) (published as US Patent Application Publication No. 20120295008), assigned to the assignee hereof and the disclosure of which is incorporated herein by reference, the optional dilution and acidification steps may be effected prior to separation of the soy protein solution from the residual soy protein source material.

The clear acidified aqueous soy protein solution may be subjected to a heat treatment to inactivate heat labile anti-nutritional factors, such as trypsin inhibitors, present in such solution as a result of extraction from the soy protein source material during the extraction step. Such a heating step also provides the additional benefit of reducing the microbial load. Generally, the protein solution is heated to a temperature of about 70° to about 160° C. for about 10 seconds to about 60 minutes, preferably about 80° to about 120° C. for about 10 seconds to about 5 minutes, more preferably about 85° to about 95° C. for about 30 seconds to about 5 minutes. The heat treated acidified soy protein solution then may be cooled for further processing as described below, to a temperature of about 2° to about 65° C., preferably about 50° C. to about 60° C.

The optionally diluted, acidified and optionally heat treated protein solution may optionally be polished by any conventional means, such as by filtering, to remove any residual particulates.

In accordance with an aspect of the present invention, the acidified aqueous soy protein solution, alternatively following the concentration and diafiltration steps described below, preferably following effecting partial concentration and diafiltration steps described below, is optionally diluted with water and then adjusted in pH to the range of about 5 to about 6.5, preferably about 5.5 to about 6.0, to effect protein precipitation and fractionation. Such pH adjustment may be effected using any conventionally suitable food grade alkali, such as, for example, but not limited to, aqueous sodium hydroxide solution or aqueous potassium hydroxide solution or mixtures thereof, preferably aqueous sodium hydroxide solution. The protein that precipitates at such pH is collected by any conventional means such as centrifugation and the resulting solution is re-acidified to a pH of about 1.5 to about 4.4, preferably about 2 to about 4, by the addition of any conventionally suitable food grade acid, such as, for example, but not limited to, hydrochloric acid or phosphoric acid or mixtures thereof, preferably hydrochloric acid, to result in a re-acidified aqueous soy protein solution, preferably a clear re-acidified aqueous soy protein solution. This re-acidified aqueous soy protein solution contains the less astringent protein species. The re-acidified aqueous soy protein solution may optionally be polished by any conventional means, such as by filtering, followed by processing according to the steps described below.

The protein precipitated at a pH of about 5 to about 6.5 and separated from the resulting solution may be further processed. The precipitate, which is the more astringent protein fraction (when tasted at low pH), may optionally be washed with water, optionally pasteurized using conditions described below, and then optionally dried by any conventional procedure, such as for example, but not limited to, spray drying or freeze drying. Alternatively, the precipitate may optionally be washed with water, adjusted in pH within the range of about 6 to about 8 and then optionally dried. The washed precipitate sample may be pasteurized using conditions described below, before or after adjustment of the pH within the range of about 6 to about 8. In another alternative, the precipitate may be re-dispersed in water at a pH of about 1.5 to about 4.4, preferably about 2 to about 4, then membrane processed as described below, then optionally pasteurized using conditions described below and then optionally dried. As a further alternative, the precipitate may be re-dispersed in water at a pH of about 1.5 to about 4.4, preferably about 2 to about 4, membrane processed as described below, adjusted in pH to about 6 to about 8, and then optionally dried. The re-dispersed and membrane processed sample may be pasteurized using conditions described below, before or after adjustment of the pH within the range of about 6 to about 8.

The acidified aqueous soy protein solution may be concentrated prior to fractionation by pH adjustment as described above. Such a concentration step increases the protein concentration of the solution while maintaining the ionic strength thereof substantially constant. Such a concentration step generally is effected to provide a concentrated soy protein solution having a protein concentration of about 50 to about 300 g/L, preferably about 100 to about 200 g/L. When the acidified aqueous protein solution is partially concentrated before precipitation and removal of the more astringent protein at pH of about 5 to about 6.5, the concentration step is effected preferably to a protein concentration of below about 50 g/L. The concentrated or partially concentrated acidified aqueous solution may be diluted with water prior to the pH adjustment step in order to reduce the viscosity of the sample and facilitate the recovery of the protein precipitated by the pH adjustment.

The re-acidified aqueous soy protein solution may also be concentrated to increase the protein concentration thereof while maintaining the ionic strength thereof substantially constant. Such a concentration step generally is effected to provide a concentrated re-acidified soy protein solution having a protein concentration of about 10 to about 300 g/L, preferably about 100 to about 200 g/L. When the re-acidified aqueous protein solution is partially concentrated, the concentration step is effected preferably to a protein concentration of less than about 10 g/L.

Such concentration steps may be effected in any conventional manner consistent with batch or continuous operation, such as by employing any conventional selective membrane technique, such as for example, but not limited to, ultrafiltration or diafiltration, using membranes, such as hollow-fibre membranes or spiral-wound membranes, with a suitable molecular weight cut-off, such as about 1,000 to about 1,000,000 daltons, preferably about 1,000 to about 100,000 daltons, more preferably about 1,000 to about 10,000 daltons, having regard to differing membrane materials and configurations, and, for continuous operation, dimensioned to permit the desired degree of concentration as the aqueous protein solution passes through the membranes.

As is well known, ultrafiltration and similar selective membrane techniques permit low molecular weight species to pass therethrough while preventing higher molecular weight species from so doing. The low molecular weight species include not only the ionic species of the salt but also low molecular weight materials extracted from the source material, such as carbohydrates, pigments, low molecular weight proteins and the anti-nutritional trypsin inhibitors. The molecular weight cut-off of the membrane is usually chosen to ensure retention of a significant proportion of the protein in the solution, while permitting contaminants to pass through having regard to the different membrane materials and configurations.

The concentrated acidified or concentrated re-acidified soy protein solution may be subjected to a diafiltration step using water or a dilute saline solution. The diafiltration solution may be at its natural pH or at a pH equal to that of the protein solution being diafiltered or at any pH value in between. Such diafiltration may be effected using from about 1 to about 40 volumes of diafiltration solution, preferably about 2 to about 25 volumes of diafiltration solution. In the diafiltration operation, further quantities of contaminants are removed from the aqueous soy protein solution by passage through the membrane with the permeate. This purifies the aqueous protein solution and may also reduce its viscosity. The diafiltration operation may be effected until no significant further quantities of contaminants or visible colour are present in the permeate or in the case of the re-acidified protein solution, until the retentate has been sufficiently purified so as, when dried, to provide a soy protein isolate with a protein content of at least about 90 wt % (N×6.25) d.b. Such diafiltration may be effected using the same membrane as for the concentration step. However, if desired, the diafiltration step may be effected using a separate membrane with a different molecular weight cut-off, such as a membrane having a molecular weight cut-off in the range of about 1,000 to about 1,000,000 daltons, preferably about 1,000 to about 100,000 daltons, more preferably about 1,000 to about 10,000 daltons, having regard to different membrane materials and configuration.

Alternatively, the diafiltration step may be applied to the acidified or re-acidified aqueous protein solution prior to concentration or to partially concentrated acidified or partially concentrated re-acidified aqueous protein solution. Diafiltration may also be applied at multiple points during the concentration process. When diafiltration is applied prior to concentration or to partially concentrated solution, the resulting diafiltered solution may then be fully concentrated. Viscosity reduction achieved by diafiltering multiple times as the protein solution is concentrated may allow a higher final, fully concentrated protein concentration to be achieved. In the case of the re-acidified protein solution, this would reduce the volume of material to be dried.

An antioxidant may be present in the diafiltration medium during at least part of the diafiltration step. The antioxidant may be any conventional antioxidant, such as for example, but not limited to sodium sulfite or ascorbic acid or mixtures thereof. The quantity of antioxidant employed in the diafiltration medium depends on the materials employed and may vary from about 0.01 to about 1 wt %, preferably about 0.05 wt %. The antioxidant serves to inhibit the oxidation of any phenolics present in the soy protein solution.

The optional concentration steps and the optional diafiltration steps may be effected at any conventional temperature, generally about 2° to about 65° C., preferably about 50° to about 60° C., and for the period of time to effect the desired degree of concentration. The temperature and other conditions used to some degree depend upon the membrane equipment used to effect the membrane processing, the desired protein concentration of the solution and the efficiency of the removal of contaminants to the permeate, all of which would be understood and determinable by persons skilled in the art.

The concentration and diafiltration steps employed in the purification of the re-acidified protein solution may be effected herein in such a manner that the reduced astringency soy protein product recovered contains less than about 90 wt % protein (N×6.25) d.b., such as at least about 60 wt % protein (N×6.25) d.b. By partially concentrating and/or partially diafiltering the re-acidified protein solution, it is possible to only partially remove contaminants. This protein solution may then be dried to provide a soy protein product with lower levels of purity. The soy protein products of the present invention are highly soluble and able to produce less astringent protein solutions, preferably clear, less astringent protein solutions, under acidic conditions.

As alluded to earlier, soy contains anti-nutritional trypsin inhibitors. The level of trypsin inhibitor activity in the final soy protein product can be controlled by the manipulation of various process variables.

Heat treatment of the acidified aqueous soy protein solution may be used to inactivate heat-labile trypsin inhibitors. The partially concentrated or fully concentrated acidified soy protein solution may also be heat treated to inactivate heat labile trypsin inhibitors. Such a heat treatment may also be applied to the re-acidified soy protein solution. When the heat treatment is applied to a solution that is not already fully concentrated, the resulting heat treated solution may then be additionally concentrated.

Acidifying or re-acidifying and membrane processing the soy protein solution at a lower pH, such as about 1.5 to about 3, preferably 1.5 to 3, may reduce the trypsin inhibitor activity relative to processing the solution at higher pH, such as about 3 to about 4.4, preferably 3 to 4.4. When the re-acidified protein solution is concentrated and diafiltered at the low end of the pH range, it may be desired to raise the pH of the retentate prior to drying. The pH of the concentrated and diafiltered protein solution may be raised to the desired value, for example a pH of about 3 by the addition of any conventional food grade alkali, such as, for example, but not limited to, sodium hydroxide or potassium hydroxide or mixtures thereof, preferably sodium hydroxide.

Further, a reduction in trypsin inhibitor activity may be achieved by exposing soy materials to reducing agents that disrupt or rearrange the disulfide bonds of the inhibitors. Suitable reducing agents include, but are not limited to, sodium sulfite, cysteine and N-acetylcysteine and mixtures thereof.

The addition of such reducing agents may be effected at various stages of the overall process. The reducing agent may be added with the soy protein source material in the extraction step, may be added to the clarified aqueous soy protein solution following removal of residual soy protein source material, may be added to the optionally diafiltered retentate before drying or may be dry blended with the dried soy protein product. The addition of the reducing agent may be combined with the heat treatment step and membrane processing steps, as described above.

If it is desired to retain active trypsin inhibitors in the protein products, this can be achieved by eliminating or reducing the intensity of the heat treatment step, not utilizing reducing agents, and/or operating the concentration and diafiltration steps at the higher end of the pH range, such as about 3 to about 4.4, preferably 3 to 4.4.

Any of the optionally concentrated and optionally diafiltered protein solutions described above may be subject to a further defatting operation, if required, as described in U.S. Pat. Nos. 5,844,086 and 6,005,076. Alternatively, defatting of the optionally concentrated and optionally diafiltered protein solutions may be achieved by any other conventional procedure.

Any of the optionally concentrated and optionally diafiltered aqueous protein solutions described above may be treated with an adsorbent, such as powdered activated carbon or granulated activated carbon, to remove colour and/or odour compounds. Such adsorbent treatment may be carried out under any conventional conditions, generally at the ambient temperature of the protein solution. For powdered activated carbon, an amount of about 0.025% to about 5% w/v, preferably about 0.05% to about 2% w/v, may be employed. The adsorbent may be removed from the soy protein solution by any conventional means, such as by filtration.

The optionally concentrated and optionally diafiltered re-acidified aqueous soy protein solutions described above may be dried by any conventional technique, such as for example, but not limited to, spray drying or freeze drying. A pasteurization step may be effected on the soy protein solutions prior to drying. Such pasteurization may be effected under any conventional pasteurization conditions. Generally, the optionally concentrated and optionally diafiltered re-acidified soy protein solution is heated to a temperature of about 55° to about 75° C., for about 15 seconds to about 60 minutes. The pasteurized soy protein solution then may be cooled for drying, preferably to a temperature of about 25° to about 40° C.

Each of the soy protein products obtained by the procedures described above has a protein content at least about 60 wt % (N×6.25) d.b. Preferably, the soy protein products are isolates with a protein content in excess of about 90 wt % (N×6.25) d.b., preferably at least about 100 wt %, (N×6.25) d.b.

The less astringent soy protein products produced herein are soluble in an acidic aqueous environment, making the products ideal for incorporation into acidic beverages, to provide protein fortification thereto. Such beverages have a wide range of acidic pH values, ranging from about 2.5 to about 5. The soy protein products provided herein may be added to such beverages in any conventional quantity to provide protein fortification to such beverages, for example, at least about 5 g of the soy protein per serving. The added soy protein product dissolves in the beverage and the haze level of the beverage is not increased by thermal processing. The soy protein product may be blended with dried beverage prior to reconstitution of the beverage by dissolution in water. In some cases, modification to the normal formulation of the beverages to tolerate the composition of the present invention may be necessary where components present in the beverage may adversely affect the ability of the composition of the present invention to remain dissolved in the beverage.

### EXAMPLES

### Example 1

This Example illustrates production of the reduced astringency soy protein product of the present invention.

‘a’ kg of soy white flake was added to ‘b’ L of ‘c’ M CaCl₂ solution and the mixture stirred for 30 minutes at about 60° C. Coarser suspended solids were removed by centrifugation using a decanter centrifuge. ‘d’ g of anti-foam was added and then the finer solids removed using a disc stack centrifuge to produce ‘e’ L of protein extract solution having a protein content of ‘f’ wt %. ‘g’ L of protein extract solution was combined with ‘h’ L of reverse osmosis (RO) purified water and the pH of the sample lowered to T with HCl solution (HCl diluted with an equal volume of water). T L of acidified protein solution, having a protein content of ‘k’ wt % was concentrated to ‘1’ L using a PES ultrafiltration membrane having a pore size of 100,000 daltons operated at a temperature of about ‘m’° C. ‘n’ L of concentrated protein solution was then diafiltered with ‘o’ L of RO purified water at about ‘p’° C. ‘q’ to provide ‘r’ L of concentrated, diafiltered protein solution having a protein content of ‘s’ wt %. ‘t’ L of concentrated and diafiltered protein solution was diluted with ‘u’ L of RO purified water and then the pH adjusted to about ‘v’ with NaOH solution, which caused the formation of a precipitate. ‘w’ kg of wet precipitate was removed by centrifugation to provide ‘x’ L of protein solution with a protein content of ‘y’ wt %. The pH of the protein solution was lowered to ‘z’ with HCl solution and then ‘aa’ L of re-acidified protein solution was polished by running the solution through a Membralox ceramic microfiltration membrane having a pore size of 0.80 μm and operated at ‘ab’° C. until ‘ac’ L of permeate was collected. ‘ad’ L of ‘ae’ was then reduced in volume to ‘af’ L by concentration on a PES ultrafiltration membrane having a pore size of ‘ag’ daltons operated at a temperature of about ‘A’° C. The resulting concentrated re-acidified protein solution, having a protein content of ‘ai’ wt % was then diafiltered with ‘aj’ L of RO purified water at about ‘ak’° C. ‘al’ kg of concentrated, diafiltered protein solution was obtained having a protein content of ‘am’ wt %. This represented a yield of ‘an’ % of the protein in the protein extract solution. ‘ao’ kg of concentrated, diafiltered protein solution was spray dried to yield a protein product, having a protein content of ‘ap’ % (N×6.25) d.b., termed ‘aq’ S705.

The ‘w’ kg of wet precipitate collected, having a protein content of ‘ar’ wt %, represented a yield of ‘as’ of the protein in the protein extract solution. ‘at’ kg of this precipitate was diluted with ‘au’ kg water and then spray dried to provide a dried protein product having a protein content of ‘av’% (N×6.25) d.b. that was termed ‘aq’ ‘aw’. ‘ax’ kg of the precipitate was diluted with ‘ay’ kg water then the pH adjusted to ‘az’ and the mixture pasteurized at about ‘ba’° C. for ‘bb’ minutes. The ‘bc’ sample was then spray dried to provide a dried protein product having a protein content of ‘bd’% (N×6.25) d.b. that was termed ‘aq’‘be’.

The parameters ‘a’ to ‘be’ are set forth in the following Table 1.

TABLE 1
Parameters for the production of S705 and S705P

| aq | S024-E06-13A | S024-J16-13A |
|---|---|---|
| a | 50 | 60 |
| b | 500 | 600 |
| c | 0.10 | 0.09 |
| d | Not applicable | 1 |
| e | 377.4 | 452 |
| f | 2.44 | 2.75 |
| g | 377.4 | 452 |
| h | 242.7 | 282 |
| i | 3.09 | 3.37 |
| j | 630 | 730 |
| k | 1.50 | 1.62 |
| l | 160 | 200 |
| m | 50 | 49 |
| n | 160 | 200 |
| o | 320 | 300 |
| p | 48 | 50 |
| q | Not applicable | and then further concentrated |
| r | Not recorded | 105 |
| s | 5.24 | 9.97 |
| t | Not recorded | 105 |
| u | Not recorded | 315 |
| v | 5 | 6.06 |
| w | 55.42 | Not recorded |
| x | 268 | 350 |
| y | 0.19 | 0.30 |
| z | 3.37 | 3.25 |
| aa | Not applicable | 350 |
| ab | Not applicable | 49 |
| ac | Not applicable | 320 |
| ad | 268 | 320 |
| ae | re-acidified protein solution | Microfiltration permeate |
| af | 20 | 20 |
| ag | 100,000 | 1,000 |
| ah | 49 | 56 |
| ai | 2.31 | 3.26 |
| aj | 20 | 20 |
| ak | 51 | 60 |
| al | 19.96 | 22.36 |
| am | 2.11 | 4.03 |
| an | 4.6 | 7.2 |
| ao | 19.87 | 22.36 |
| ap | 91.83 | 94.10 |
| ar | 14.98 | 21.56 |
| as | 90.1 | Not determined |
| at | 13.24 | Not applicable |
| au | 13.30 | Not applicable |
| av | 103.02 | Not applicable |
| aw | S705P-01 | Not applicable |
| ax | 8.05 | 47.06 |
| ay | 8.05 | 47.06 |
| az | 7.18 | 7.16 |
| ba | Not applicable | 66 |
| bb | Not applicable | 10 |
| bc | Not applicable | pasteurized |
| bd | 101.70 | 103.95 |
| be | S705P-02 | S705P |

### Example 2

This Example contains an evaluation of the dry colour and colour in solution of the reduced astringency soy protein products produced by the methods of Example 1.

The colour of the dry powders was assessed using a HunterLab ColorQuest XE instrument in reflectance mode. The colour values are set forth in the following Table 2:

TABLE 2
HunterLab scores for dry protein products

| Sample | L* | a* | b* |
|---|---|---|---|
| S024-E06-13A S705 | 88.08 | 0.39 | 8.22 |
| S024-J16-13A S705 | 87.04 | −0.47 | 6.84 |

As may be seen from Table 2, the reduced astringency soy protein products were light in colour.

Solutions of the reduced astringency soy protein products were prepared by dissolving sufficient protein powder to supply 0.48 g of protein in 15 ml of RO purified water. The pH of the solutions was measured with a pH meter and the colour and clarity assessed using a HunterLab ColorQuest XE instrument operated in transmission mode. The results are shown in the following Table 3.

TABLE 3
pH and HunterLab scores for solutions of
reduced astringency soy protein products

| sample | pH | L* | a* | b* | haze |
|---|---|---|---|---|---|
| S024-E06-13A S705 | 3.30 | 97.34 | −0.73 | 9.11 | 10.3 |
| S024-J16-13A S705 | 3.47 | 97.09 | −1.02 | 8.43 | 2.0 |

As may be seen from the results in Table 3, the solutions of the reduced astringency soy protein products were light in colour and low in haze.

### Example 3

This Example contains an evaluation of the solubility in water of the reduced astringency soy protein products produced by the methods of Example 1. Solubility was tested based on protein solubility (termed protein method, a modified version of the procedure of Morr et al., J. Food Sci. 50:1715-1718) and total product solubility (termed pellet method).

Sufficient protein powder to supply 0.5 g of protein was weighed into a beaker and then a small amount of RO purified water was added and the mixture stirred until a smooth paste formed. Additional water was then added to bring the volume to approximately 45 ml. The contents of the beaker were then slowly stirred for 60 minutes using a magnetic stirrer. The pH was determined immediately after dispersing the protein and was adjusted to the appropriate level (2, 3, 4, 5, 6 or 7) with diluted NaOH or HCl. For the pH adjusted samples, the pH was measured and corrected periodically during the 60 minutes stirring. After the 60 minutes of stirring, the samples were made up to 50 ml total volume with RO purified water, yielding a 1% w/v protein dispersion. The protein content of the dispersions was determined by combustion analysis using a Nitrogen Determinator (Leco Corporation, St. Joseph, Mich.). Aliquots (20 ml) of the dispersions were then transferred to pre-weighed centrifuge tubes that had been dried overnight in a 100° C. oven then cooled in a desiccator and the tubes capped. The samples were centrifuged at 7,800 g for 10 minutes, which sedimented insoluble material and yielded a supernatant. The protein content of the supernatant was measured by combustion analysis and then the supernatant and the tube lids were discarded and the pellet material dried overnight in an oven set at 100° C. The next morning the tubes were transferred to a desiccator and allowed to cool. The weight of dry pellet material was recorded. The dry weight of the initial protein powder was calculated by multiplying the weight of powder used by a factor of ((100−moisture content of the powder (%))/100). Solubility of the product was then calculated two different ways:

Solubility (protein method) (%)=(% protein in supernatant/% protein in initial dispersion)×100 1)

Solubility (pellet method) (%)=(1−(weight dry insoluble pellet material/((weight of 20 ml of dispersion/weight of 50 ml of dispersion)×initial weight dry protein powder)))×100 2)

Values calculated as greater than 100% were reported as 100%.

The solubility results obtained are set forth in the following Tables 4 and 5:

TABLE 4
Solubility of products at different pH values based on protein method

| | | Solubility (protein method) (%) | | | | | |
|---|---|---|---|---|---|---|---|
| Batch | Product | pH 2 | pH 3 | pH 4 | pH 5 | pH 6 | pH 7 |
| S024-E06-13A | S705 | 99.1 | 100 | 95.6 | 99.1 | 100 | 86.2 |
| S024-J16-13A | S705 | 100 | 100 | 100 | 67.4 | 68.5 | 93.0 |

TABLE 5
Solubility of products at different pH values based on pellet method

| | | Solubility (pellet method) (%) | | | | | |
|---|---|---|---|---|---|---|---|
| Batch | Product | pH 2 | pH 3 | pH 4 | pH 5 | pH 6 | pH 7 |
| S024-E06-13A | S705 | 93.4 | 95.2 | 97.5 | 95.8 | 85.9 | 90.3 |
| S024-J16-13A | S705 | 94.7 | 95.0 | 92.9 | 62.4 | 75.4 | 100 |

As can be seen from the results presented in Tables 4 and 5, the reduced astringency soy protein products were highly soluble in the pH range 2-4 and also had very good solubility at pH 7.

### Example 4

This Example contains an evaluation of the clarity in water of the reduced astringency soy protein products produced by the methods of Example 1.

The clarity of the 1% w/v protein solutions prepared as described in Example 3 was assessed by measuring the absorbance at 600 nm (water blank), with a lower absorbance score indicating greater clarity. Analysis of the samples on a HunterLab ColorQuest XE instrument in transmission mode also provided a percentage haze reading, another measure of clarity.

The clarity results are set forth in the following Tables 6 and 7:

TABLE 6
Clarity of protein solutions at different pH values as assessed by A600

| | | A600 | | | | | |
|---|---|---|---|---|---|---|---|
| Batch | Product | pH 2 | pH 3 | pH 4 | pH 5 | pH 6 | pH 7 |
| S024-E06-13A | S705 | 0.010 | 0.013 | 0.021 | 0.154 | 0.920 | 0.782 |
| S024-J16-13A | S705 | 0.008 | 0.012 | 0.035 | 2.579 | 1.239 | 0.012 |

TABLE 7
Clarity of protein solutions at different pH values as assessed by
HunterLab haze analysis

| | | HunterLab haze reading (%) | | | | | |
|---|---|---|---|---|---|---|---|
| Batch | Product | pH 2 | pH 3 | pH 4 | pH 5 | pH 6 | pH 7 |
| S024-E06-13A | S705 | 1.8 | 4.5 | 6.0 | 31.9 | 93.9 | 91.1 |
| S024-J16-13A | S705 | 1.5 | 2.7 | 8.8 | 97.8 | 99.6 | 2.7 |

As can be seen from the results of Tables 6 and 7, the reduced astringency soy protein products provided solutions that were low in haze at pH 2-4.

### Example 5

This Example contains an evaluation of the solubility in a soft drink (Sprite) and sports drink (Orange Gatorade) of the reduced astringency soy protein products produced by the methods of Example 1. The solubility was determined with the protein added to the beverages with no pH correction and again with the pH of the protein fortified beverages adjusted to the level of the original beverages.

When the solubility was assessed with no pH correction, a sufficient amount of protein powder to supply 1 g of protein was weighed into a beaker and then a small amount of beverage was added and the mixture stirred until a smooth paste formed. Additional beverage was then added to bring the volume to 50 ml, and then the solutions were stirred slowly on a magnetic stirrer for 60 minutes to yield a 2% protein w/v dispersion. The protein content of the samples was determined by combustion analysis then an aliquot of the protein containing beverages was centrifuged at 7,800 g for 10 minutes and the protein content of the supernatant measured.

Solubility (%)=(% protein in supernatant/% protein in initial dispersion)×100.

Values calculated as greater than 100% were reported as 100%.

When the solubility was assessed with pH correction, the pH of the soft drink (Sprite) and sports drink (Orange Gatorade) without protein was measured. A sufficient amount of protein powder to supply 1 g of protein was weighed into a beaker and then a small amount of beverage was added and the mixture stirred until a smooth paste formed. Additional beverage was added to bring the volume to approximately 45 ml, and then the solutions were stirred slowly on a magnetic stirrer for 60 minutes. The pH of the protein containing beverages was determined immediately after dispersing the protein and was adjusted to the original no-protein pH with HCl or NaOH as necessary. The pH was measured and corrected periodically during the 60 minutes stirring. After the 60 minutes of stirring, the total volume of each solution was brought to 50 ml with additional beverage, yielding a 2% protein w/v dispersion. The protein content of the samples was determined by combustion analysis then an aliquot of the protein containing beverages was centrifuged at 7,800 g for 10 minutes and the protein content of the supernatant measured.

Solubility (%)=(% protein in supernatant/% protein in initial dispersion)×100

Values calculated as greater than 100% were reported as 100%.

The results obtained are set forth in the following Table 8:

TABLE 8
Solubility of reduced astringency soy protein
products in Sprite and Orange Gatorade

| | | no pH correction | | pH correction | |
|---|---|---|---|---|---|
| | | | Solubility | | Solubility |
| | | Solubility | (%) in | Solubility | (%) in |
| | | (%) in | Orange | (%) in | Orange |
| Batch | Product | Sprite | Gatorade | Sprite | Gatorade |
| S024-E06-13A | S705 | 100 | 100 | 100 | 100 |
| S024-J16-13A | S705 | 100 | 97.9 | 100 | 100 |

As can be seen from the results of Table 8, the reduced astringency soy protein products were highly soluble in the Sprite and the Orange Gatorade.

### Example 6

This Example contains an evaluation of the clarity in a soft drink and sports drink of the reduced astringency soy protein products produced by the methods of Example 1.

The clarity of the 2% w/v protein dispersions prepared in soft drink (Sprite) and sports drink (Orange Gatorade) in Example 5 were assessed using the HunterLab haze method described in Example 4.

The results obtained are set forth in the following Table 9:

TABLE 9
HunterLab haze readings for reduced astringency soy
protein products in Sprite and Orange Gatorade

| | | no pH correction | | pH correction | |
|---|---|---|---|---|---|
| | | | Haze | | Haze |
| | | Haze | (%) in | Haze | (%) in |
| | | (%) in | Orange | (%) in | Orange |
| Batch | Product | Sprite | Gatorade | Sprite | Gatorade |
| no protein | | 0.0 | 77.2 | 0.0 | 77.2 |
| S024-E06-13A | S705 | 8.0 | 74.2 | 6.6 | 74.9 |
| S024-J16-13A | S705 | 0.9 | 65.1 | 2.6 | 66.0 |

As can be seen from the results of Table 9, the addition of the reduced astringency soy protein products to the soft drink and sports drink added little or no haze.

### Example 7

This Example contains an evaluation of the heat stability in water of the reduced astringency soy protein products produced by the methods of Example 1.

2% w/v protein solutions of the protein products were prepared in RO purified water with the pH of the solutions adjusted to about 3.0 with HCl solution. The clarity of the solutions was assessed by haze measurement with the HunterLab ColorQuest XE instrument operated in transmission mode. The solutions were then heated to 95° C., held at this temperature for 30 seconds and then immediately cooled to room temperature in an ice bath. The clarity of the heat treated solutions was then measured again.

The clarity of the protein solutions before and after heating is set forth in the following Table 10:

TABLE 10
Effect of heat treatment on clarity of 2% w/v protein
solutions of reduced astringency soy protein products

| | | haze before heat | haze after heat |
|---|---|---|---|
| Batch | Product | treatment (%) | treatment (%) |
| S024-E06-13A | S705 | 8.0 | 0.4 |
| S024-J16-13A | S705 | 2.4 | 0.8 |

As can be seen from the results in Table 10, the solutions of reduced astringency soy protein product were substantially clear before heat treatment and the level of haze was actually reduced by the heat treatment.

### Example 8

This Example describes the production of soy protein products according to the methods of the aforementioned U.S. Pat. Nos. 8,563,071 and 8,691,318 and U.S. patent application Ser. No. 13/879,418 filed Aug. 1, 2013 (US Patent Publication No. 2013-0316069 published Nov. 28, 2013) (“S701”).

‘a’ kg of ‘b’ was combined with ‘c’ L of ‘d’ M CaCl2 solution at ‘e’ and agitated for ‘f’ minutes to provide an aqueous protein solution. The bulk of the residual solids were removed and the resulting protein solution was partially clarified by centrifugation with a decanter centrifuge. The sample was then further clarified by centrifugation with a disc stack centrifuge to provide ‘g’ L of centrate having a protein content of ‘h’ % by weight. The sample was additionally clarified by filtration to provide L of protein solution having a protein content of T % by weight.

‘k’ L of clarified protein solution was then added to ‘1’ L of RO purified water and the pH of the sample lowered to ‘m’ with diluted HCl.

The diluted and acidified protein extract solution was reduced in volume from ‘n’ L to ‘o’ L by concentration on a polyethersulfone (PES) membrane having a molecular weight cut-off of ‘p’ daltons, operated at a temperature of about ‘q’° C. The acidified protein solution, with a protein content of ‘r’ wt %, was diafiltered with ‘s’ L of RO purified water, with the diafiltration operation conducted at about ‘t’° C. The resulting diafiltered protein solution was then ‘u’. The concentrated and diafiltered protein solution, having a protein content of ‘v’ % by weight, represented a yield of ‘w’ wt % of the initial clarified protein solution. ‘x’ kg of the concentrated and diafiltered protein solution was diluted with ‘y’ L of water then ‘z’ kg of the sample dried to yield a product found to have a protein content of ‘aa’% (N×6.25) d.b. The product was given designation ‘ab’ S701.

The parameters ‘a’ to ‘ab’ for five runs are set forth in the following Table 11:

TABLE 11
Parameters for the runs to produce S701

| ab | S005-K18-08A | S024-J07-13A | |
|---|---|---|---|
| a | 60 | 60 | |
| b | defatted, minimally heat | defatted soy white flakes | |
| | processed soy flour | | |
| c | 600 | 600 | |
| d | 0.15 | 0.09 | |
| e | ambient temperature | 60° | C. |
| f | 60 | 30 | |
| g | 463 | 439 | |
| h | 3.59 | 2.73 | |
| i | 410 | not applicable | |
| j | 2.63 | not applicable | |
| k | 410 | 439 | |
| l | 410 | 286 | |
| m | 3.07 | 3.23 | |
| n | 820 | 717 | |
| o | 70 | 217 | |
| p | 10,000 | 100,000 | |
| q | 29 | 51 | |
| r | 11.21 | 4.92 | |
| s | 350 | 326 | |
| t | 29 | 49 | |
| u | not applicable | further concentrated | |
| v | 13.34 | 11.68 | |
| w | 89.6 | 78.0 | |
| x | 36.21 kg | 80 | L |
| y | not applicable | 40 | L |
| z | 36.21 kg | 41.32 | kg |

| | | |
|---|---|---|
| aa | 102.71 | 99.14 |

### Example 9

This Example illustrates a comparison of the astringency level of the S024-E06-13A S705 prepared as described in Example 1 with that of the S005-K18-08A S701 prepared as described in Example 8.

Samples were prepared for sensory evaluation by weighing out sufficient protein powder to supply a certain weight of protein and then dissolving the protein powder in purified drinking water at a ratio of 50 parts water per weight of supplied protein. The pH of both samples was 3.31. An informal panel of seven panellists was asked to blindly taste the samples and indicate which was less astringent.

Five out of seven panellists indicated that the S024-E06-13A S705 was less astringent and two panellists identified the S005-K18-08A S701 as less astringent.

### Example 10

This Example illustrates a comparison of the astringency level of the S024-J16-13A S705 prepared as described in Example 1 with that of the S005-K18-08A S701 prepared as described in Example 8.

Samples were prepared for sensory evaluation by weighing out sufficient protein powder to supply a certain weight of protein and then dissolving the protein powder in purified drinking water at a ratio of 50 parts water per weight of supplied protein. The pH of the S024-J16-13A S705 solution was lowered from 3.45 to 3.30 with food grade HCl solution. The pH of the S005-K18-08A solution was 3.28. An informal panel of eight panellists was asked to blindly taste the samples and indicate which was less astringent.

Seven out of eight panellists indicated that the S024-J16-13A S705 was less astringent and one panellist identified the S005-K18-08A S701 as less astringent.

### Example 11

This Example illustrates a comparison of the astringency level of the S024-E06-13A S705 prepared as described in Example 1 with that of the S005-J07-13A S701 prepared as described in Example 8.

Samples were prepared for sensory evaluation by weighing out sufficient protein powder to supply a certain weight of protein and then dissolving the protein powder in purified drinking water at a ratio of 50 parts water per weight of supplied protein. The pH of the S024-E06-13A S705 solution was 3.30. The pH of the S024-J07-13A S701 solution was lowered from 3.46 to 3.30 with food grade HCl solution. An informal panel of eight panellists was asked to blindly taste the samples and indicate which was less astringent.

Six out of eight panellists indicated that the S024-E06-13A S705 was less astringent and two panellists identified the S024-J07-13A S701 as less astringent.

### Example 12

This Example illustrates a comparison of the astringency level of the S024-J16-13A S705 prepared as described in Example 1 with that of the 5005-J07-13A S701 prepared as described in Example 8.

Samples were prepared for sensory evaluation by weighing out sufficient protein powder to supply a certain weight of protein and then dissolving the protein powder in purified drinking water at a ratio of 50 parts water per weight of supplied protein. The pH of the S024-J16-13A S705 solution was 3.49. The pH of the S024-J07-13A solution was 3.54. An informal panel of eight panellists was asked to blindly taste the samples and indicate which was less astringent.

Four out of eight panellists indicated that the S024-J16-13A S705 was less astringent, two panellists identified the S024-J07-13A S701 as less astringent and two panellists could not identify which sample was less astringent.

### Example 13

This Example contains an evaluation of the dry colour and colour in solution of the co-products (S705P) of the production of reduced astringency soy protein products, prepared according to the method of Example 1.

The colour of the dry powders was assessed using a HunterLab ColorQuest XE instrument in reflectance mode. The colour values are set forth in the following Table 12:

TABLE 12
HunterLab scores for dry protein products

| Sample | L* | a* | b* |
|---|---|---|---|
| S024-E06-13A S705P-01 | 86.58 | 0.68 | 9.38 |
| S024-E06-13A S705P-02 | 86.68 | 0.70 | 9.47 |
| S024-J16-13A S705P | 86.71 | 0.10 | 9.42 |

As may be seen from the results in Table 12, the co-products generally were darker, redder and more yellow than the reduced astringency soy protein products.

Solutions of the co-products from the preparation of reduced astringency soy protein products were prepared by dissolving sufficient protein powder to supply 0.48 g of protein in 15 ml of RO purified water. The pH of the solutions was measured with a pH meter and the colour and clarity assessed using a HunterLab ColorQuest XE instrument operated in transmission mode. The results are shown in the following Table 13.

TABLE 13
pH and HunterLab scores for solutions of soy protein products

| sample | pH | L* | a* | b* | haze |
|---|---|---|---|---|---|
| S024-E06-13A S705P-01 | 4.48 | 37.42 | 5.54 | 27.55 | 96.7 |
| S024-E06-13A S705P-02 | 6.77 | 45.61 | 3.47 | 24.57 | 97.0 |
| S024-J16-13A S705P | 7.40 | 51.22 | 1.56 | 18.51 | 95.6 |

As may be seen from the results in Table 13, the solutions of the co-products were high in haze. The solutions were also darker, redder and more yellow than the solutions of the reduced astringency soy products.

### Example 14

This Example contains an evaluation of the solubility in water of the co-products of the production of the reduced astringency soy products, prepared by the methods of Example 1. Solubility was tested based on protein solubility (termed protein method, a modified version of the procedure of Morr et al., J. Food Sci. 50:1715-1718).

Sufficient protein powder to supply 0.5 g of protein was weighed into a beaker and then a small amount of RO purified water was added and the mixture stirred until a smooth paste formed. Additional water was then added to bring the volume to approximately 45 ml. The contents of the beaker were then slowly stirred for 60 minutes using a magnetic stirrer. The pH was determined immediately after dispersing the protein and was adjusted to the appropriate level (2, 3, 4, 5, 6, or 7) with diluted NaOH or HCl. The pH was then measured and corrected periodically during the 60 minutes stirring. After the 60 minutes of stirring, the samples were made up to 50 ml total volume with RO purified water, yielding a 1% w/v protein dispersion. The protein content of the dispersions was determined by combustion analysis using a Leco Nitrogen Determinator. The samples were then centrifuged at 7,800 g for 10 minutes, which sedimented insoluble material and yielded a supernatant. The protein content of the supernatant was measured by combustion analysis.

Solubility of the product was then calculated:

Solubility (protein method) (%)=(% protein in supernatant/% protein in initial dispersion)×100 1)

Values calculated as greater than 100% were reported as 100%.

The solubility results obtained are set forth in the following Table 14:

TABLE 14
Solubility of products at different pH values based on protein method

| | | Solubility (protein method) (%) | | | | | |
|---|---|---|---|---|---|---|---|
| Batch | Product | pH 2 | pH 3 | pH 4 | pH 5 | pH 6 | pH 7 |
| S024-E06-13A | S705P-02 | 42.2 | 29.6 | 11.8 | 11.2 | 12.0 | 13.9 |
| S024-J16-13A | S705P | 42.6 | 41.7 | 31.9 | 1.0 | 0.0 | 27.7 |

As may be seen from the results in Table 14, the co-products of the production of the reduced astringency soy protein products were generally low in solubility.

### Example 15

This Example contains an evaluation of the water binding capacity of the co-products of the production of the reduced astringency soy products, prepared by the methods of Example 1.

Protein powder (1 g) was weighed into centrifuge tubes (50 ml) of known weight. To this powder was added approximately 20 ml of RO purified water at the natural pH. The contents of the tubes were mixed using a vortex mixer at moderate speed for 1 minute. The samples were incubated at room temperature for 5 minutes then mixed with the vortex mixer for 30 seconds. This was followed by incubation at room temperature for another 5 minutes followed by another 30 seconds of vortex mixing. The samples were then centrifuged at 1,000 g for 15 minutes at 20° C. After centrifugation, the supernatant was carefully poured off, ensuring that all solid material remained in the tube. The centrifuge tube was then re-weighed and the weight of water saturated sample was determined.

Water binding capacity (WBC) was calculated as:

WBC (ml/g)=(mass of water saturated sample−mass of initial sample)/(mass of initial sample×total solids content of sample)

The water binding capacity results obtained are set forth in the following Table 15.

TABLE 15
Water binding capacity of various products

| product | WBC (ml/g) |
|---|---|
| S024-E06-13A S705P-02 | 4.82 |
| S024-J16-13A S705P | 4.94 |

As may be seen from the results of Table 15, the co-products of the production of the reduced astringency soy protein products had good water binding capacities.

### Example 16

This Example illustrates the preparation of a soy protein isolate by conventional isoelectric precipitation (IEP).

30 kg of soy white flake was added to 300 L of RO purified water at ambient temperature and the pH adjusted to 8.5 by the addition of 1M sodium hydroxide solution. The sample was agitated for 30 minutes to provide an aqueous protein solution. The pH of the extraction was monitored and maintained at 8.5 throughout the 30 minutes. The residual soy white flake was removed and the resulting protein solution clarified by centrifugation and filtration to produce 278.7 L of filtered protein solution having a protein content of 2.93% by weight. The pH of the protein solution was adjusted to 4.5 by the addition of HCl that had been diluted with an equal volume of water and a precipitate formed. The precipitate was collected by centrifugation then washed by re-suspending it in 2 volumes of RO purified water. The washed precipitate was then collected by centrifugation. A total of 32.42 kg of washed precipitate was obtained with a protein content of 18.15 wt %. This represented a yield of 72.0% of the protein in the clarified extract solution. An aliquot of 16.64 kg of the washed precipitate was combined with an equal weight of RO purified water and then the pH of the sample adjusted to 6 with sodium hydroxide. The pH adjusted sample was then spray dried to yield an isolate with a protein content of 93.80% (N×6.25) d.b. The product was designated S013-K19-09A conventional IEP pH 6.

### Example 17

This Example is a sensory evaluation of the S024-E06-13A S705P-02 product prepared as described in Example 1 with the conventional soy protein isolate product prepared as described in Example 14.

Samples were prepared for sensory evaluation by weighing out sufficient protein powder to supply a certain weight of protein and then dissolving the protein powder in purified drinking water at a ratio of 50 parts water per weight of supplied protein. The pH of the S705P-02 solution was found to be 6.47. The initial pH of the S013-K19-09A conventional IEP pH 6 sample was 5.31 and it was adjusted to 6.49 with food grade sodium hydroxide solution. An informal panel of nine panellists was asked to blindly taste the samples and indicate which had less beany flavour.

Seven out of nine panellists found the S024-E06-13A S705P-02 sample to have less beany flavour and two panellists thought that the S013-K19-09A conventional IEP sample was less beany.

### Example 18

This Example is a sensory evaluation of the S024-J16-13A S705P product prepared as described in Example 1 with the conventional soy protein isolate product prepared as described in Example 16.

Samples were prepared for sensory evaluation by weighing out sufficient protein powder to supply a certain weight of protein and then dissolving the protein powder in purified drinking water at a ratio of 50 parts water per weight of supplied protein. The pH of the S705P solution was found to be 7.38. The initial pH of the S013-K19-09A conventional IEP pH 6 sample was 5.44 and it was adjusted to 7.35 with food grade sodium hydroxide solution. An informal panel of nine panellists was asked to blindly taste the samples and indicate which had less beany flavour.

Eight out of nine panellists found the S024-J16-13A S705P sample to have less beany flavour while the ninth panellist could not identify one sample as less beany.

### Example 19

This Example illustrates the molecular weight profile of the soy protein products prepared as described in Example 1 and the commercial soy protein products Pro Fam 825 and Pro Fam 873 (both ADM, Decatur, IL).

Molecular weight profiles were determined by size exclusion chromatography using a Varian ProStar HPLC system equipped with a 300 x 7.8 mm Phenomenex BioSep S-2000 series column. The column contained hydrophilic bonded silica rigid support media, 5 micron diameter, with 145 Angstrom pore size.

Before the soy protein samples were analyzed, a standard curve was prepared using a Biorad protein standard (Biorad product #151-1901) containing proteins with known molecular weights between 17,000 Daltons (myoglobulin) and 670,000 Daltons (thyroglobulin) with Vitamin B12 added as a low molecular weight marker at 1,350 Daltons. A 0.9% w/v solution of the protein standard was prepared in water, filtered with a 0.45 μm pore size filter disc then a 50 μL aliquot run on the column using a mobile phase of 0.05M phosphate/0.15M NaCl, pH 6 containing 0.02% sodium azide. The mobile phase flow rate was 1 mL/min and components were detected based on absorbance at 280 nm. Based on the retention times of these molecules of known molecular weight, a regression formula was developed relating the natural log of the molecular weight to the retention time in minutes.

Retention time (min)=−0.955×ln(molecular weight)+18.502(r²=0.999)

For the analysis of the soy protein samples, 0.05M NaCl, pH 3.5 containing 0.02% sodium azide was used as the mobile phase and also to dissolve dry samples. Protein samples were mixed with mobile phase solution to a concentration of 1% w/v, placed on a shaker for at least 1 hour then filtered using 0.45 μm pore size filter discs. Sample injection size was 50 μL. The mobile phase flow rate was 1 mL/minute and components were detected based on absorbance at 280 nm.

The above regression formula relating molecular weight and retention time was used to calculate retention times that corresponded to molecular weights of 100,000 Da, 15,000 Da, 5,000 Da and 1,000 Da. The HPLC ProStar system was used to calculate the peak areas lying within these retention time ranges and the percentage of protein ((range peak area/total protein peak area)×100) falling in a given molecular weight range was calculated. Note that the data was not corrected by protein response factor.

The molecular weight profiles of the products prepared as described in Example 1 and the commercial products are shown in Table 16.

TABLE 16
Molecular weight profile of soy protein products

| | % >100,000 | % 15,000-100,000 | % 5,000-15,000 | % 1,000-5,000 |
|---|---|---|---|---|
| product | Da | Da | Da | Da |
| S024-E06-13A S705 | 61.2 | 32.9 | 3.5 | 2.4 |
| S024-J16-13A S705 | 49.0 | 33.7 | 9.8 | 7.6 |
| S024-E06-13A S705P-01 | 41.3 | 37.2 | 8.0 | 13.4 |
| S024-E06-13A S705P-02 | 30.6 | 39.3 | 10.1 | 20.0 |
| S024-J16-13A S705P | 31.2 | 40.4 | 9.8 | 18.6 |
| Pro Fam 825 | 3.2 | 30.2 | 32.5 | 34.1 |
| Pro Fam 875 | 0.5 | 19.6 | 33.7 | 46.2 |

As may be seen from the results presented in Table 16, the molecular weight profiles of the products prepared according to Example 1 were different from the molecular weight profiles of the commercial soy protein products.

### Example 20

This Example is another illustration of the molecular weight profile of the soy protein products of the present invention, prepared as described in Example 1 and the commercial soy protein products Pro Fam 825 and Pro Fam 873 (both ADM, Decatur, IL).

Molecular weight profiles were determined by size exclusion chromatography using a Varian ProStar HPLC system equipped with a 300×7 8 mm Phenomenex BioSep S-2000 series column. The column contained hydrophilic bonded silica rigid support media, 5 micron diameter, with 145 Angstrom pore size.

Before the soy protein samples were analyzed, a standard curve was prepared using a Biorad protein standard (Biorad product #151-1901) containing proteins with known molecular weights between 17,000 Daltons (myoglobulin) and 670,000 Daltons (thyroglobulin) with Vitamin B12 added as a low molecular weight marker at 1,350 Daltons. A 0.9% w/v solution of the protein standard was prepared in water, filtered with a 0.45 μm pore size filter disc then a 50 μL aliquot run on the column using a mobile phase of 0.05M phosphate/0.15M NaCl, pH 6 containing 0.02% sodium azide. The mobile phase flow rate was 1 mL/min and components were detected based on absorbance at 280 nm. Based on the retention times of these molecules of known molecular weight, a regression formula was developed relating the natural log of the molecular weight to the retention time in minutes.

Retention time (min)=−0.865×ln(molecular weight)+17.154(r2=0.98)

For the analysis of the soy protein samples, 0.05M phosphate/0.15M NaCl, pH 6 containing 0.02% sodium azide was used as the mobile phase and also to dissolve dry samples. Protein samples were mixed with mobile phase solution to a concentration of 1% w/v, placed on a shaker for at least 1 hour then filtered using 0.45 μm pore size filter discs. Sample injection size was 50 μL. The mobile phase flow rate was 1 mL/minute and components were detected based on absorbance at 280 nm.

The above regression formula relating molecular weight and retention time was used to calculate retention times that corresponded to molecular weights of 100,000 Da, 15,000 Da, 5,000 Da and 1,000 Da. The HPLC ProStar system was used to calculate the peak areas lying within these retention time ranges and the percentage of protein ((range peak area/total protein peak area)×100) falling in a given molecular weight range was calculated. Note that the data was not corrected by protein response factor.

The molecular weight profiles of the products prepared as described in Examples 1-5 and the commercial products are shown in Table 17.

TABLE 17
Molecular weight profile of soy protein products

| | % >100,000 | % 15,000-100,000 | % 5,000-15,000 | % 1,000-5,000 |
|---|---|---|---|---|
| product | Da | Da | Da | Da |
| S024-E06-13A S705 | 25.3 | 53.6 | 9.9 | 11.2 |
| S024-J16-13A S705 | 19.7 | 48.1 | 14.9 | 17.3 |
| S024-E06-13A S705P-01 | 6.1 | 27.4 | 7.0 | 59.5 |
| S024-E06-13A S705P-02 | 17.2 | 27.5 | 9.7 | 45.5 |
| S024-J16-13A S705P | 74.4 | 13.0 | 3.3 | 9.2 |
| Pro Fam 825 | 36.2 | 30.8 | 17.3 | 15.6 |
| Pro Fam 875 | 26.3 | 30.1 | 21.5 | 22.0 |

As may be seen from the results presented in Table 17, the molecular weight profiles of the products prepared according to Example 1 were different from the molecular weight profiles of the commercial soy protein products.

### Example 20

This Example contains an evaluation of the phytic acid content of the soy protein products produced as described in Example 1. Phytic acid content was determined using the method of Latta and Eskin (J. Agric. Food Chem., 28: 1313-1315).

The results obtained are set forth in the following Table 18.

TABLE 18
Phytic acid content of protein products

| product | % phytic acid d.b. |
|---|---|
| S024-E06-13A S705 | 0.00 |
| S024-J16-13A S705 | 0.00 |
| S024-E06-13A S705P-02 | 0.01 |
| S024-J16-13A S705P | 0.00 |

As may be seen from the results in Table 18, all of the products tested had either very low or undetectable levels of phytic acid.

### SUMMARY OF THE DISCLOSURE

In summary of this disclosure, the present invention provides soy protein products, preferably soy protein isolates, which have reduced astringency when tasted in an acidic solution such as an acidic beverage. Modifications are possible within the scope of the present invention.

1. A method of preparing a soy protein product with reduced astringency when tasted in aqueous solution at a pH below about 5, which method comprises:
(a) extracting a soy protein source with an aqueous calcium salt solution to cause solubilization of soy protein from the protein source and to form an aqueous soy protein solution,
(b) separating the aqueous soy protein solution from residual soy protein source,
(c) optionally diluting the aqueous soy protein solution,
(d) adjusting the pH of the aqueous soy protein solution to a pH of about 1.5 to about 4.4 to produce an acidified soy protein solution,
(e) optionally clarifying the acidified soy protein solution if it is not already clear,
(f) alternatively from steps (b) to (e), optionally diluting and then adjusting the pH of the combined aqueous soy protein solution and residual soy protein source to a pH of about 1.5 to about 4.4 and then separating the acidified, preferably clear, soy protein solution from residual soy protein source, and
(g) fractionating the proteins in the acidified soy protein solution of step (e) or (f) to separate lower molecular weight, less astringent proteins from higher molecular weight, more astringent proteins by adjusting the pH of the acidified soy protein solution to a pH value of about 5 to about 6.5 to precipitate the higher molecular weight, more astringent proteins from the acidified soy protein solution and provide a pH-adjusted soy protein solution,
(h) removing the precipitate from the pH-adjusted soy protein solution,
(i) adjusting the pH of the pH-adjusted soy protein solution to a pH value of about 1.5 to about 4.4, to form a re-acidified aqueous soy protein solution, and
(j) optionally drying the re-acidified aqueous soy protein solution to provide a soy protein product of lesser astringency.

2-24. (canceled)

25. A soy protein product having a protein content of at least about 60% wt % (N×6.25) d.b. and which
is completely soluble in aqueous media at acid pH values of less than about 4.4;
is heat stable in aqueous media at acid values of less than about 4.4;
does not require stabilizers or other additives to maintain the protein product in solution or suspension;
is low in phytic acid; and
is low in astringency when tasted in aqueous solution at a pH below about 5.

26-31. (canceled)

32-66. (canceled)

67. A soy protein product which has a protein content of at least about 60 wt % (N×6.25) d.b., and which has a solubility at 1% protein w/v in water at a pH of about 2 to about 7 of greater than about 50%.

68-72. (canceled)

73. A soy protein product having a molecular weight profile which is selected from the group consisting of:
(A) about 39 to about 72% greater than about 100,000 Da;
about 22 to about 44% from about 15,000 to about 100,000 Da;
about 0 to about 20% from about 5,000 to about 15,000 Da; and
about 0 to about 18% from about 1,000 to about 5,000 Da;
(B) about 20 to about 52% greater than about 100,000 Da;
about 27 to about 51% from about 15,000 to about 100,000 Da;
about 0 to about 21% from about 5,000 to about 15,000 Da; and
about 3 to about 31% from about 1,000 to about 5,000 Da
(C) about 6 to about 36% greater than about 100,000 Da;
about 38 to about 64% from about 15,000 to about 100,000 Da;
about 0 to about 28% from about 5,000 to about 15,000 Da; and
about 1 to about 28% from about 1,000 to about 5,000 Da; and
(D) about 1 to about 80% greater than about 100,000 Da;
about 8 to about 33% from about 15,000 to about 100,000 Da;
about 0 to about 13% from about 5,000 to about 15,000 Da; and
about 4 to about 65% from about 1,000 to about 5,000 Da.
